(19) United States
(12) Patent Application Publication
(10) Pub. No.: US 2024/0385826 A1
(43) Pub. Date: Nov. 21, 2024

(54) CENTER DEVICE AND DATA PACKAGE GENERATION METHOD

(71) Applicant: DENSO CORPORATION, Kariya-city (JP)

(72) Inventors: Masaaki ABE, Kariya-city (JP); Hideo YOSHIMI, Kariya-city (JP); Koto TOMATSU, Kariya-city (JP)

(21) Appl. No.: 18/788,604

(22) Filed: Jul. 30, 2024

Related U.S. Application Data
(63) Continuation of application No. PCT/JP2023/000985, filed on Jan. 16, 2023.

(30) Foreign Application Priority Data
Feb. 10, 2022 (JP) 2022-019597

(51) Int. Cl. G06F 8/65; B60R 16/023

(52) U.S. Cl. CPC G06F 8/65; B60R 16/023

(57) ABSTRACT

A center device that manages data to be written to a plurality of electronic control devices installed in a vehicle is configured to generate a package including update data to be distributed to the vehicle, and register identification information assigned to logic for generating the package in accordance with a specification of a master device that is installed in the vehicle, receives a package distributed from a center device and transfers update data to the electronic control device. The logic is registered. A manifest file having a description of the identification information is registered.

### CROSS REFERENCE TO RELATED APPLICATION

The present application is a continuation application of International Patent Application No. PCT/JP2023/000985 filed on Jan. 16, 2023 which designated the U.S. and claims the benefit of priority from Japanese Patent Application No. 2022-019597 filed on Feb. 10, 2022. The entire disclosures of all of the above applications are incorporated herein by reference.

### TECHNICAL FIELD

The present disclosure relates to a center device that manages data to be written to a plurality of electronic control devices installed in a vehicle, and a data package generation method.

### BACKGROUND

A related art discloses a technique in which an ECU update program is distributed from a server to an in-vehicle device using over-the-air (OTA), and the update program is rewritten on the vehicle side.

### SUMMARY

A center device that manages data to be written to a plurality of electronic control devices installed in a vehicle is configured to generate a package including update data to be distributed to the vehicle, and register identification information assigned to logic for generating the package in accordance with a specification of a master device that is installed in the vehicle, receives a package distributed from a center device, and transfers update data to the electronic control device. The logic is registered. A manifest file having a description of the identification information is registered.

### BRIEF DESCRIPTION OF DRAWINGS

Objects, features and advantages of the present disclosure will become more apparent from the following detailed description made with reference to the accompanying drawings. In the drawings:

FIG. 1 is a functional block diagram illustrating a package distribution system including a center device according to an embodiment;

FIG. 2 is a functional block diagram illustrating a vehicle-side system;

FIG. 3 is a diagram (part 1) illustrating an example of C-ECU information and logic IDs registered in a logic ID management DB;

FIG. 4 is a diagram (part 2) illustrating an example of the C-ECU information and the logic IDs registered in the logic ID management DB;

FIG. 5 is a diagram (part 3) illustrating an example of the C-ECU information and the logic IDs registered in the logic ID management DB;

FIG. 6 is a diagram illustrating an example of logic IDs and logic specifications registered in the logic management DB;

FIG. 7 is a diagram illustrating a manifest file;

FIG. 8 is a flowchart illustrating process contents of a preliminary preparation phase;

FIG. 9 is a flowchart illustrating contents of a determination process phase;

FIG. 10 is a diagram conceptually illustrating the contents of the determination process phase;

FIG. 11 is a flowchart illustrating process contents of a distribution preparation phase;

FIG. 12 is a flowchart illustrating the contents of the distribution phase;

FIG. 13 is a diagram illustrating an overall process image of a package generation process;

FIG. 14A is a diagram (part 1) illustrating a package generation process corresponding to a CP-CP storage;

FIG. 14B is a diagram (part 2) illustrating the package generation process corresponding to the CP-CP storage;

FIG. 15A is a diagram (part 1) illustrating a package generation process corresponding to AP-AP streaming;

FIG. 15B is a diagram (part 2) illustrating the package generation process corresponding to the AP-AP streaming;

FIG. 16A is a diagram (part 1) illustrating a package generation process corresponding to CP-CP streaming;

FIG. 16B is a diagram (part 2) illustrating the package generation process corresponding to the CP-CP streaming;

FIG. 17A is a diagram (part 1) illustrating a package generation process corresponding to the CP-CP storage and CP-CP streaming;

FIG. 17B is a diagram (part 2) illustrating the package generation process corresponding to the CP-CP storage and CP-CP streaming;

FIG. 18A is a diagram (part 1) illustrating a package generation process corresponding to an AP-CP storage;

FIG. 18B is a diagram (part 2) illustrating the package generation process corresponding to the AP-CP storage;

FIG. 19A is a diagram (part 1) illustrating a package generation process corresponding to AP-CP streaming;

FIG. 19B is a diagram (part 2) illustrating the package generation process corresponding to the AP-CP streaming;

FIG. 20A is a diagram (part 1) illustrating a package generation process corresponding to the AP-CP storage and AP-AP streaming; and

FIG. 20B is a diagram (part 2) illustrating the package generation process corresponding to the AP-CP storage and AP-AP streaming.

### DETAILED DESCRIPTION

In recent years, with diversification of vehicle control such as a driving support function and an automated driving function, the scale of application programs for vehicle control, diagnosis, and the like installed in electronic control devices (hereinafter referred to as electronic control units (ECUs)) of vehicles is increasing. In addition, with the version upgrades due to functional improvements or the like, there are increasing opportunities to rewrite application programs of ECUs, so-called reprogramming. On the other hand, with the development of communication networks and the like, connected car technology has also become widespread.

When the update program is distributed using OTA, it is necessary to generate a data package for distribution. On the other hand, the vehicle-side system includes, for example, a data communication module (DCM) that directly communicates with a center device, a so-called target ECU that is an electronic control device to rewrite an update program, a central ECU that is a master device for transferring an update program received via the DCM to the target ECU, and the like. The specifications of the package depend on the specifications of the central ECU, necessitating the generation of the distribution package according to the specifications of the central ECU.

However, conventionally, a specific process for generating the distribution package according to the specifications of the central ECU has not been disclosed.

The present disclosure provides a center device capable of generating a distribution package according to specifications of a master device, and a data package generation method.

According to one aspect of the present disclosure, a center device that manages data to be written to a plurality of electronic control devices installed in a vehicle is provided. The center device includes: a package generation section that is configured to generate a package including update data to be distributed to the vehicle; a logic identification information registration section that is configured to register identification information assigned to logic for generating the package in accordance with a specification of a master device that is installed in the vehicle, receives a package distributed from a center device, and transfers update data to the electronic control device; a logic registration section in which the logic is registered; and a file registration section in which a manifest file having a description of the identification information is registered. The package generation section includes an identification information acquisition section that acquires the identification information with reference to the manifest file, a master information acquisition section that acquires information on a master device corresponding to the identification information from the logic identification information registration section, and a logic acquisition section that acquires a logic corresponding to the identification information from the logic identification information registration section. The package generation section generates a package on a basis of the logic.

That is, by registering the manifest file in advance in the file registration section, the identification information assigned to the logic can be acquired from the file. When the identification information is acquired, the information on the master device and the logic corresponding to the identification information can be acquired, so that the package generation section can generate a package corresponding to the specifications of the master device on the basis of the acquired logic.

According to another aspect of the present disclosure, the identification information acquisition section acquires the identification information from the manifest file on condition that the identification information acquisition section failed to acquire information on the master device from an external server. When the necessary information is available from an external server at the time when the request to generate the package is generated, the package can be generated based on the information acquired from the server. When the necessary information cannot be obtained from the server, the package can be generated by acquiring the identification information from the manifest file.

According to another aspect of the present disclosure, the center device further includes a package distribution section that is configured to distribute the package to the vehicle. The package generation section associates the generated package with information related to a master device corresponding to the identification information, and transmits the package to the package distribution section. Accordingly, the package distribution section can distribute a package to a vehicle equipped with the master device to be distributed.

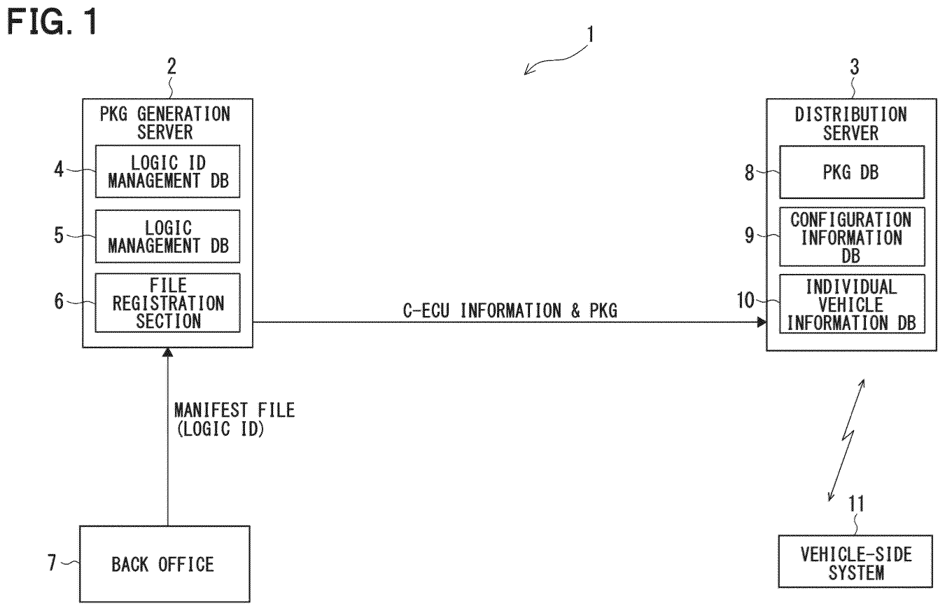

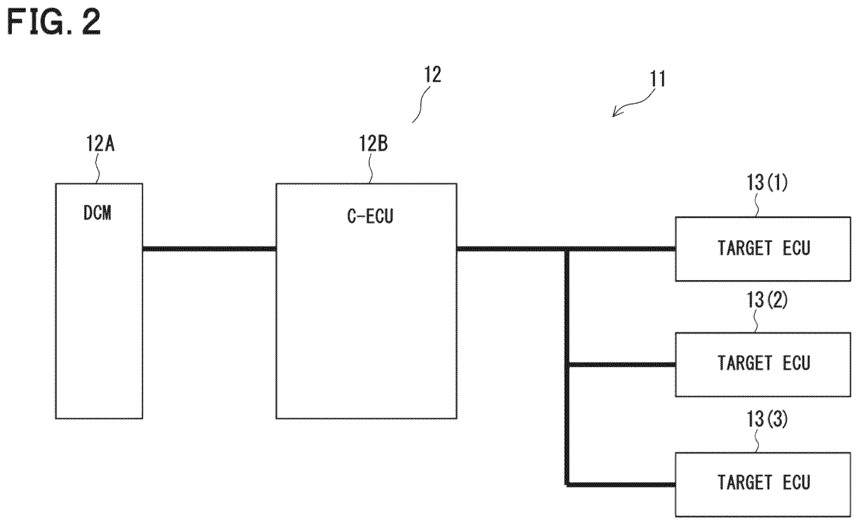

Hereinafter, an embodiment will be described. As illustrated in FIG. 2, a vehicle-side system 11 includes an OTA master 12 and a target ECU 13. The OTA master 12 includes a data communication module (DCM) 12A and a central ECU 12B. The DCM 12A directly communicates with a center device 1 illustrated in FIG. 1. When acquiring a distribution package received from the center device 1, the OTA master 12 transfers update data included in the acquired distribution package to each target ECU 13. Hereinafter, the “central ECU” is referred to as a “C-ECU”.

As illustrated in FIG. 1, the center device 1 of the present embodiment includes a PKG generation server 2 and a distribution server 3. The PKG generation server 2 includes a logic ID management DB 4, a logic management DB 5, and a file registration section 6. “PKG” means “package” and “DB” means a database.

The PKG generation server 2 generates a data package to be distributed to the vehicle-side system 11, and the generated distribution package is distributed to the vehicle-side system 11 via the distribution server 3. The format of the distribution package varies depending on the specifications of the C-ECU 12B of each vehicle-side system 11. In the present embodiment, information for generating a distribution package corresponding to the specifications of the C-ECU 12B is referred to as “logic”. Note that what is simply referred to as a “vehicle” below indicates a vehicle in which the vehicle-side system 11 is installed.

When a change occurs in specifications for any of the C-ECUs 12B, a back office 7 of an original equipment manufacturer (OEM), which is an external server, identifies an ID that is an identifier of logic corresponding to the specifications, generates a manifest file including the ID, and provides the manifest file to the center device 1. An ID that is an identifier of logic is also referred to as logic identification information or a logic ID. When a change occurs in specifications for any of the C-ECUs 12B, the back office 7 may identify the logic corresponding to the specifications in addition to the logic ID. The PKG generation server 2 registers the provided manifest file in the file registration section 6. The logic ID is managed in the logic ID management DB 4 together with the information on the corresponding C-ECU 12B, and the logic corresponding to each ID is managed in the logic management DB 5.

When the information on the C-ECU 12B to which the update data is to be transmitted is input from the distribution server 3, the PKG generation server 2 acquires a logic ID corresponding to the C-ECU 12B from the logic ID management DB 4. When the logic corresponding to the acquired logic ID is acquired from the logic management DB 5, a package is generated according to the logic. The generated package is registered in a package DB 8 and distributed to the vehicle-side system 11 and the C-ECU 12B as the transmission targets via the distribution server 3.

The distribution server 3 also includes a configuration information DB 9 and an individual vehicle information DB 10. In the configuration information DB 9, regular configuration information is registered as vehicle configuration information for each vehicle model. The regular configuration information is configuration information of a vehicle authorized by a public institution. The configuration information is identification information related to the hardware and software of the ECU installed in the vehicle, and is an example of vehicle-related information. The configuration information also includes identification information of a system configuration including a plurality of ECUs and identification information of a vehicle configuration including a plurality of systems. In addition, vehicle constraint information related to program updates may be registered as the configuration information.

Individual vehicle information uploaded from an individual vehicle is registered in the individual vehicle information DB 10. The individual vehicle information is the configuration information held by each vehicle at that time. At the time of registering individual vehicle information uploaded from a vehicle, the individual vehicle information is checked against the configuration information of the same type of vehicle registered in the configuration information DB 9. When the two pieces of information do not match, the newer information is overwritten to match the two pieces of information. This is referred to as “vehicle configuration information synchronization”.

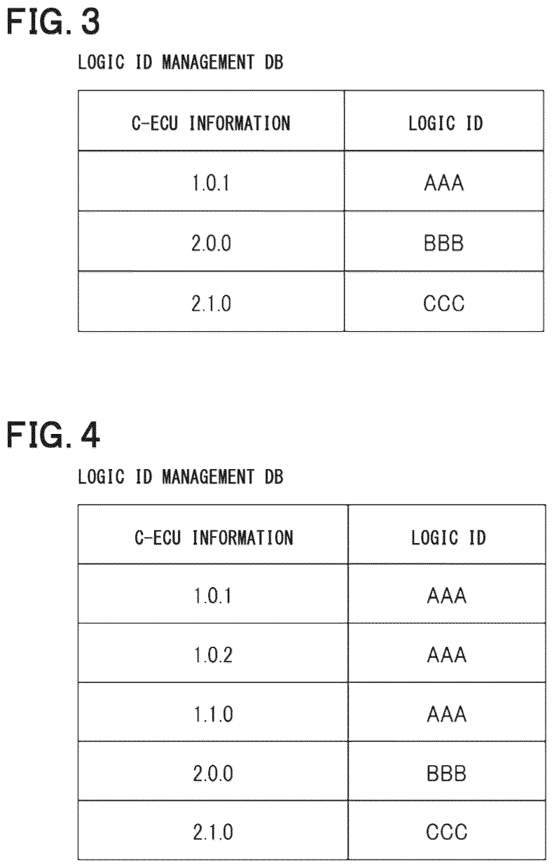

As illustrated in an example in FIG. 3, in the logic ID management DB 4, the software version or the software ID of each C-ECU 12B is set as C-ECU information, and the logic ID corresponding to the C-ECU information is registered. In FIG. 4, two pieces of C-ECU information “1.0.2” and “1.1.0”, each having a logic ID of “AAA”, are added.

In the examples illustrated in FIGS. 3 and 4, the C-ECU information is represented as separated by period symbols. “1.0.2” or the like indicates, for example, a revision build at the lowest level, a minor version in the center, and a major version at the highest level. When the higher-digit number increases, the lower-digit number is reset to zero. For example, in “1.0.2”, when the number in the center increases from “0” to “1”, the number “2” at the lowest level becomes “0”.

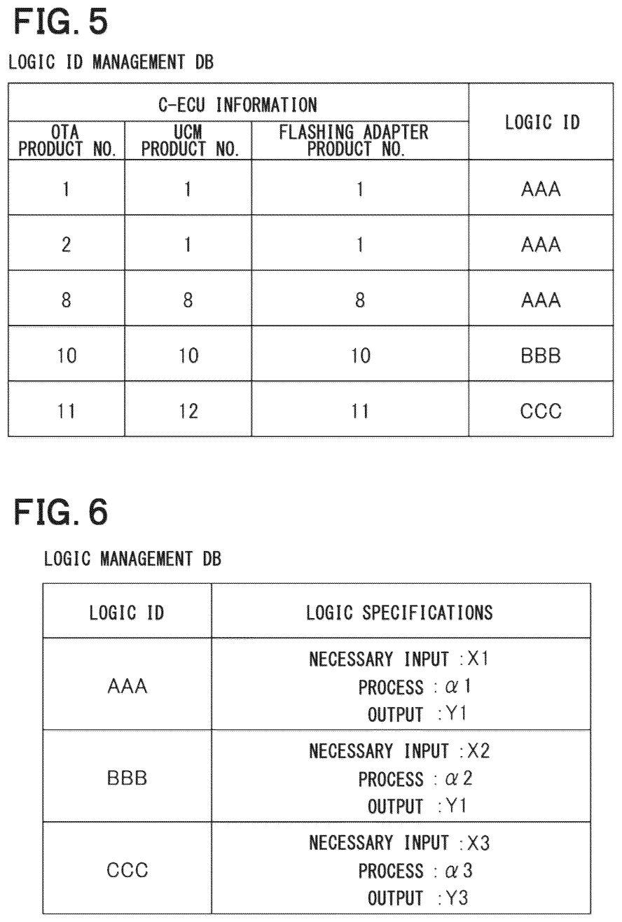

In another example illustrated in FIG. 5, the C-ECU information is a combination of a plurality of product numbers. For example, it is an OTA product number, a UCM (Update Configuration Management) product number, a flashing adaptor product number, or the like. The UCM and flashing adaptor are described in AUTOSAR, and hence the details thereof are omitted.

As illustrated in FIG. 6, specifications of a logic corresponding to the logic ID are registered in the logic management DB 5. The logic specifications define inputs, processes, and outputs necessary to generate the data package.

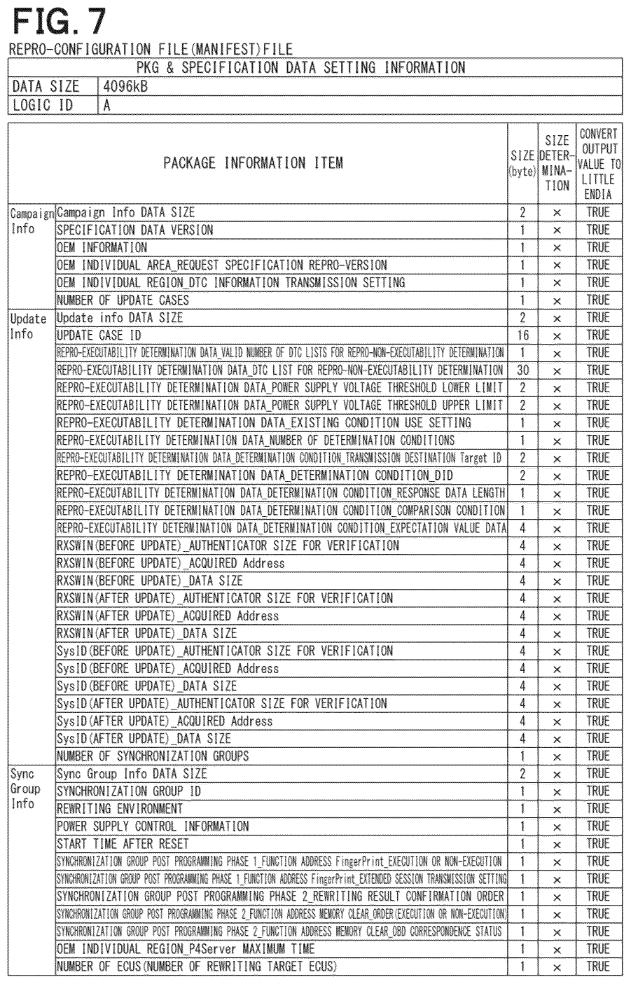

As illustrated in FIG. 7, the manifest file includes a data size and a logic ID of the package, campaign information, update information that is information related to reprogramming, synchronization group information, and the like.

Next, the action of the present embodiment will be described.

### <Preliminary Preparation Phase>

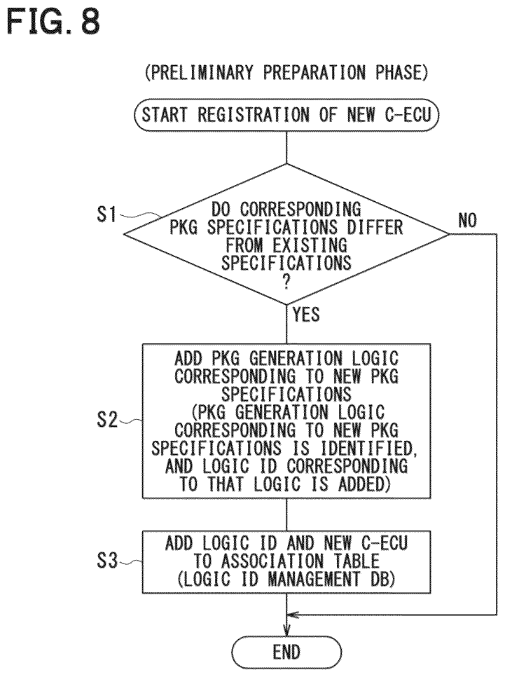

As illustrated in FIG. 8, when the registration of the information on the new C-ECU 12B is started, the PKG generation server 2 determines whether the specifications of the package corresponding to the C-ECU 12B differ from the specifications of the existing package (S1). When the specifications are the same as those of the existing package (NO), the process is terminated. When the specifications differ from the existing package specifications (YES), the generation logic of the package corresponding to the new specifications is added, and an ID is assigned to the logic (S2). The logic ID and the corresponding information on the C-ECU 12B are associated with each other and added to the logic ID management DB 4 (S3). In addition, the added information on the logic ID is notified to the back office 7 of the OEM.

### <Determination Process Phase>

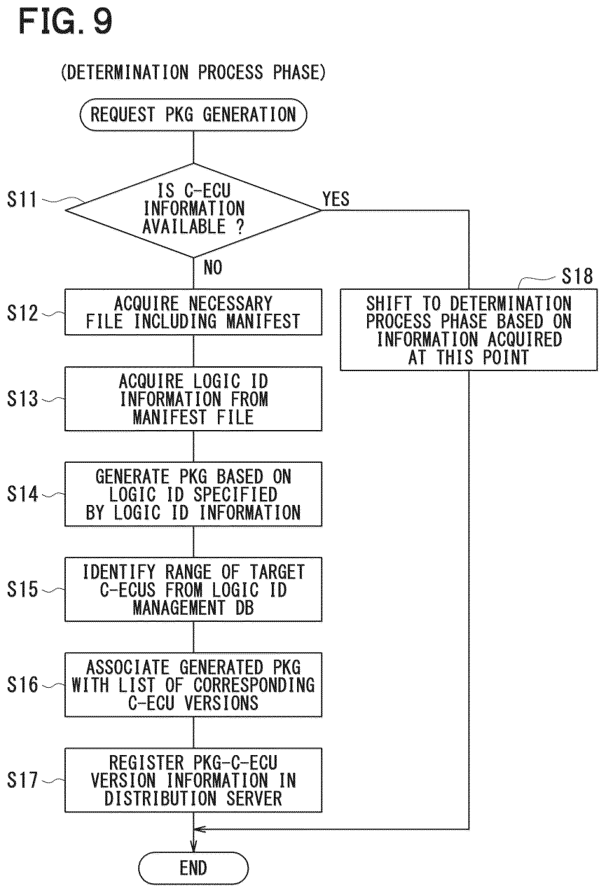

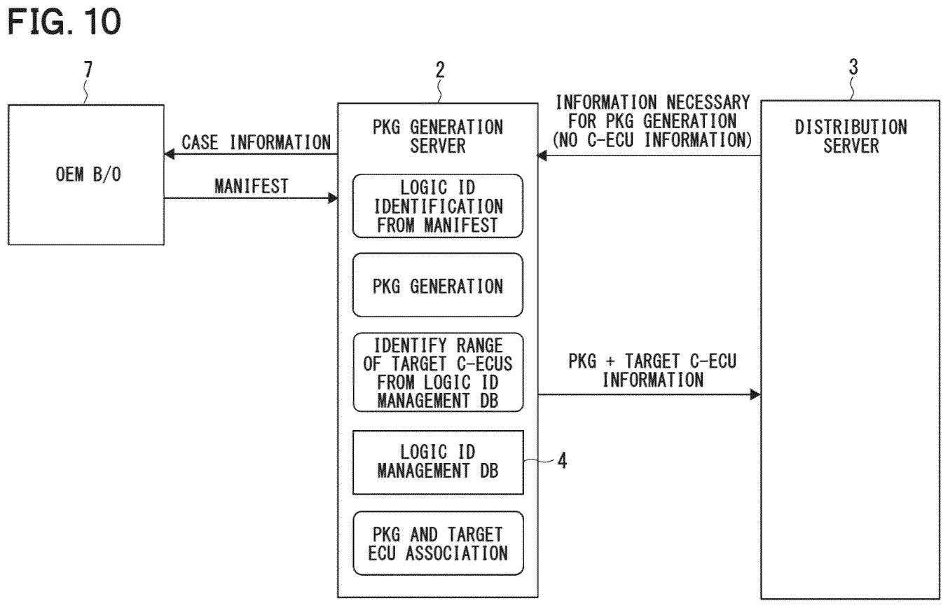

As illustrated in FIGS. 9 and 10, when there is a package generation request from the distribution server 3, the PKG generation server 2 determines whether information on the corresponding C-ECU 12B can be acquired from the back office 7 of the OEM at that time (S11). When the information can be acquired, the process proceeds to a determination process phase that is executed according to the information (S18). However, the content of the determination process phase is irrelevant to the gist of the present embodiment, and thus the description thereof is omitted. In brief, the logic ID is identified by referring to the logic ID management DB 4 on the basis of the information on the C-ECU 12B. The package is generated according to the logic indicated by the logic ID with reference to the logic management DB 5.

On the other hand, when the information on the corresponding C-ECU 12B cannot be acquired from the back office 7, the PKG generation server 2 acquires a file necessary for generating a package, including the manifest file (S12). When the logic ID information is acquired from the manifest file (S13), a package based on the logic ID is generated (S14). In addition, the range of the C-ECUs 12B to which the generated package is to be distributed is identified from the logic ID management DB 4 (S15).

The “range” above is the range of the C-ECUs 12B associated with the logic indicated by the ID, which is represented by the minimum version of the C-ECU 12B associated with the logic and the minimum version of a C-ECU 12B associated with logic after the above logic is switched. For example, the versions of the C-ECU 12B adopting the logic ID: AAA is in a range where the above two are associated, such as 1.0.1, 1.0.2, 1.0.3, and so on.

For example, in FIG. 3, when the logic ID: AAA is acquired as the logic ID information, “1.0.1” is registered in the logic ID management DB 4 as the C-ECU information. This corresponds to the minimum version of the C-ECU 12B associated with the logic indicated by the ID. In addition, “2.0.0” is registered as the next version of “1.0.1”. This corresponds to the minimum version of a C-ECU 12B that is associated with logic after the above logic is switched. Therefore, the range of the C-ECUs 12B corresponding to the logic ID: AAA is “1.0.1” or more and less than “2.0.0”. Here, the range is described as being less than “2.0.0” because, according to the information from the logic ID management DB 4, the range of the C-ECUs 12B corresponding to the logic ID: AAA also includes “1.99.0” and “1.0.99”.

Alternatively, as illustrated in FIG. 4, two pieces of C-ECU information “1.0.2” and “1.1.0”, each having the logic ID of “AAA”, may be added. In this case, the range of the C-ECUs 12B corresponding to the logic ID: AAA are “1.0.1”, “1.0.2”, and “1.1.0”.

Then, the generated package is associated with the version list and range of the C-ECUs 12B corresponding to the package (S16), and the associated version information is registered in the distribution server 3 (S17).

### <Distribution Preparation Phase>

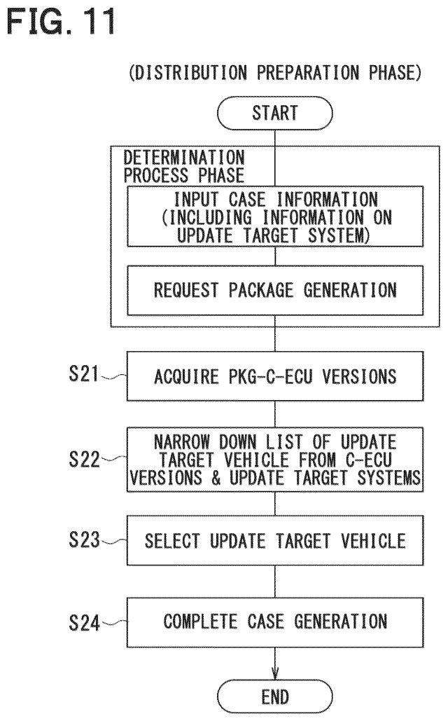

As illustrated in FIG. 11, the distribution preparation phase is executed following the determination process phase. Upon acquiring the versions of the C-ECUs 12B for the package generated in the distribution preparation phase, that is, the range of the C-ECUs 12B to which one package is applicable (S21), the distribution server 3 narrows down the list of the update target vehicles from the acquired versions and the update target systems (S22). To perform this narrowing down, data that associates the vehicle with the C-ECU 12B and that the distribution server 3 refers to is prepared is prepared, and the distribution server 3 performs narrowing down so as to distribute only to the vehicle in which the acquired version of the C-ECU 12B is installed. Since the distribution server 3 includes the configuration information DB 9 and the individual vehicle information DB 10, the distribution server 3 narrows down the range of the C-ECUs 12B to information on the C-ECU 12B that actually exists.

Then, the update target vehicle is selected (S23). Here, an OEM operations manager approves that the information on the C-ECU 12B matches the vehicle to which the campaign is to be applied. For example, only a specific vehicle, such as a test vehicle, can be selected as the update target vehicle. The distribution server 3 identifies a target vehicle by matching on the basis of information on the C-ECUs 12B with a plurality of packages associated with one case and prepares for the distribution of the generated package to the vehicle to which that package is to be distributed. In this case, for example, when the version of the update program distributed by the campaign is equal to or higher than the version of the target C-ECU 12B, a data table or the like for determining “OK” is used. This completes the preparation for distribution, that is, the generation of the case (S24).

### <Distribution Phase>

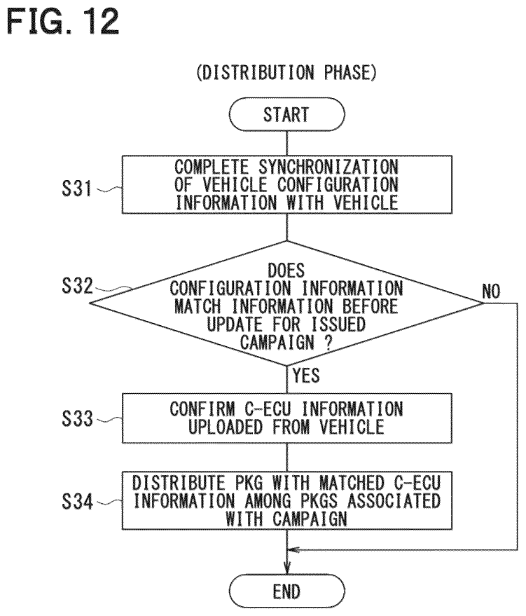

As illustrated in FIG. 12, when the process of synchronizing the vehicle configuration information with the vehicle is completed (S31), the distribution server 3 determines whether the vehicle configuration information matches the vehicle configuration information before the update for the issued campaign information (S32). When both pieces of information match, the information on the C-ECU 12B uploaded from the vehicle is confirmed (S33). Among the packages associated with the campaign information, those with the matched information on the C-ECU 12B are distributed as the target vehicle (S34).

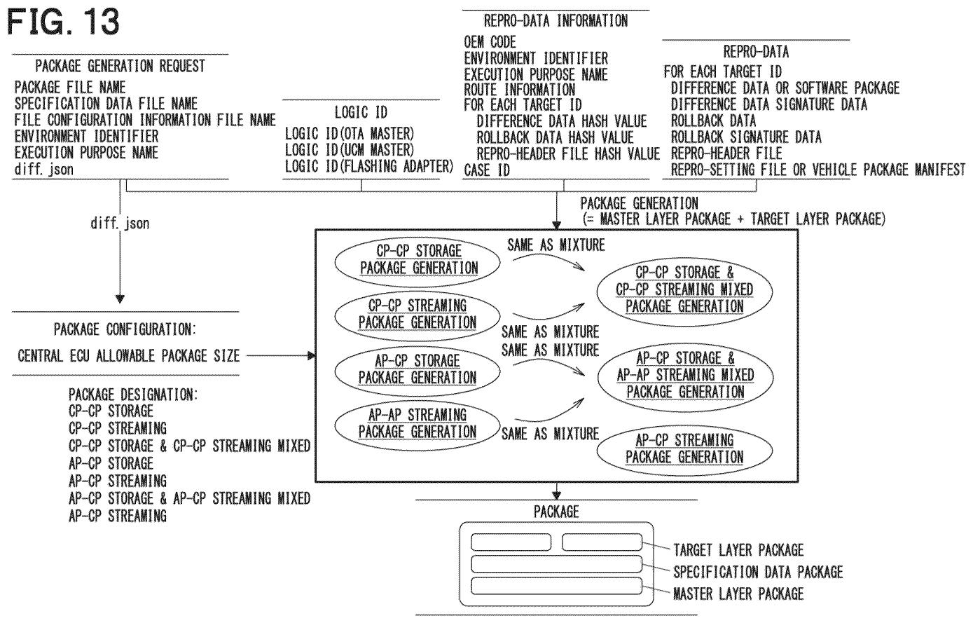

FIG. 13 schematically illustrates a package generation process corresponding to step S14. “Repro” means “reprogramming”. There are data update methods of the following types: a storage method in which all update programs are downloaded from the center device 1 to a memory on the vehicle side before the update is performed; and a streaming method in which the update is performed while the update program is being downloaded from the center device 1 to the vehicle side. The package generation process is divided into seven cases depending on the combination of the platform types the C-ECU 12B and the target ECU 13, and the storage and streaming methods.

### <CP-CP Storage>

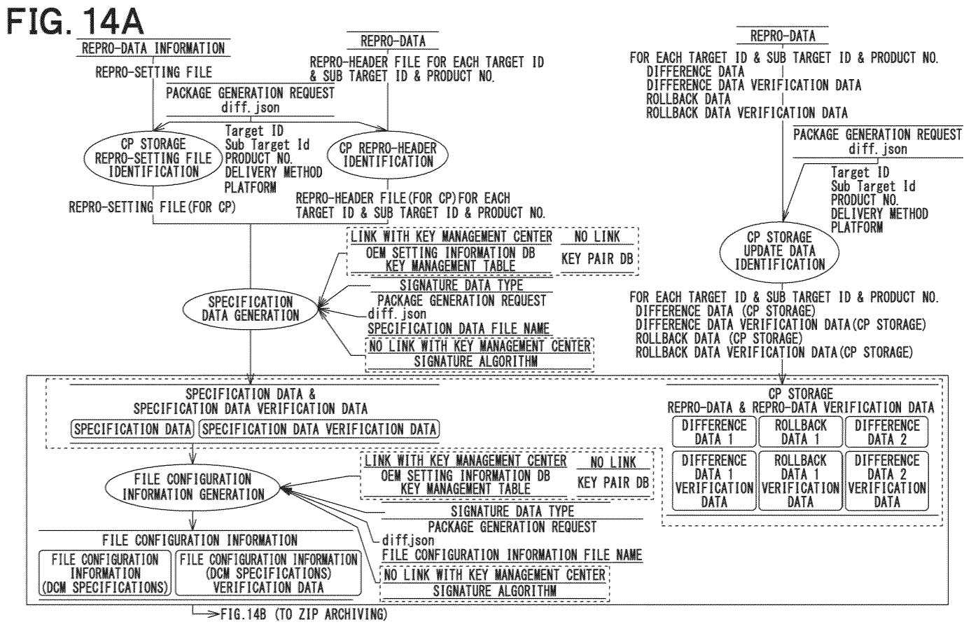

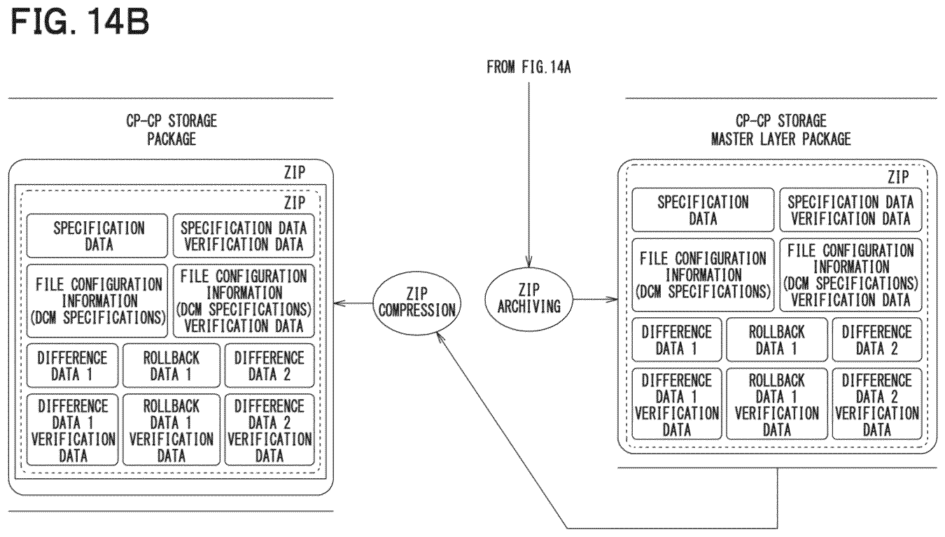

As illustrated in FIG. 14A and FIG. 14B, by identifying the logic for generating the package, the corresponding CP storage repro-setting file, CP repro-header, and CP storage update data are acquired. Specification data is generated from the repro-setting file and the repro-header, and verification data is added to the specification data. For the update data, difference data from the data before the update and rollback data are generated, and verification data for each of those pieces of data is added. After the file configuration information is generated and its verification data is added, the file configuration information and the verification data are collectively archived to obtain a master layer package corresponding to the CP-CP storage. Finally, the package is compressed into a ZIP file.

### <AP-AP Streaming>

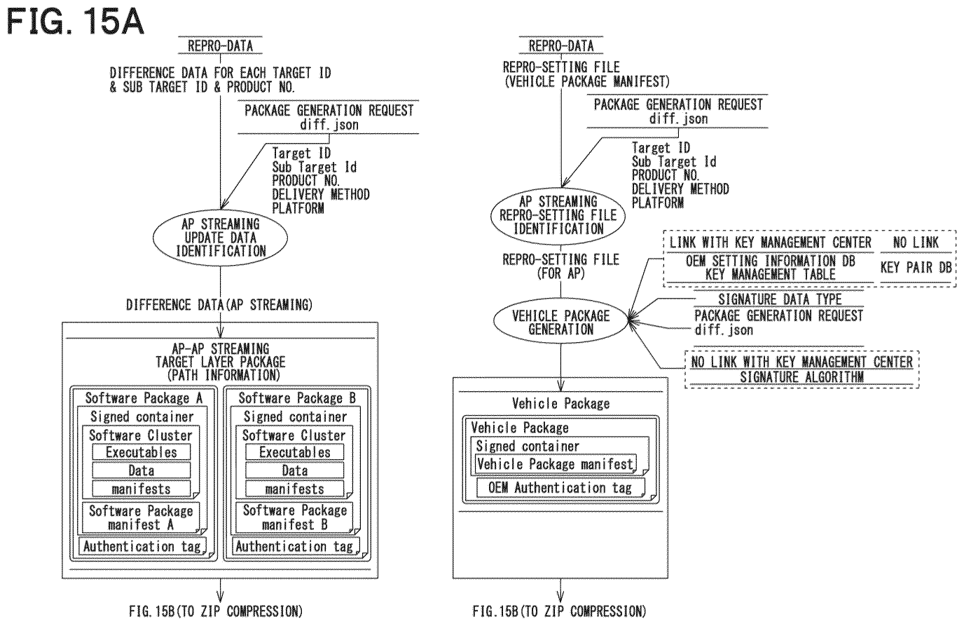

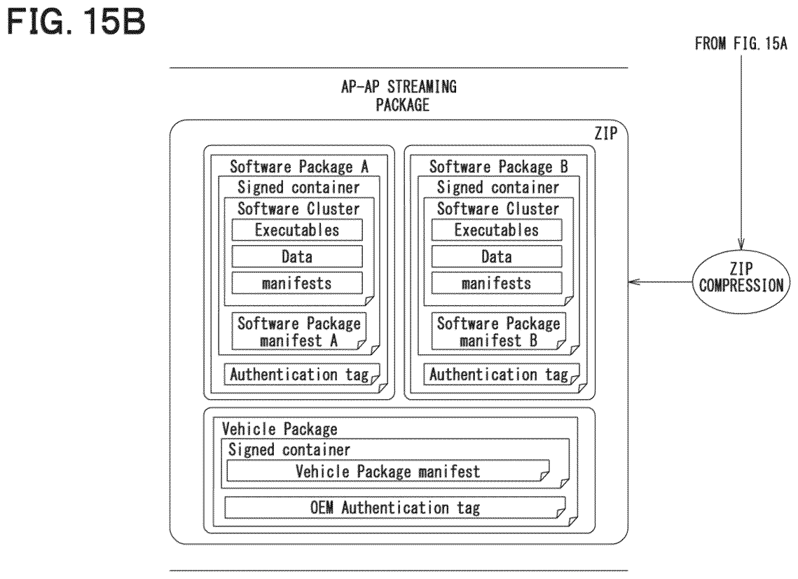

As illustrated in FIG. 15A and FIG. 15B, an AP streaming update data file and an AP streaming repro-setting file are identified according to the logic. For the update data, difference data is generated as described above, and an AP-AP streaming target layer package is generated. A vehicle package is generated from the repro-setting file for AP. These are collectively compressed into a ZIP file to form a final package.

### <CP-CP Streaming>

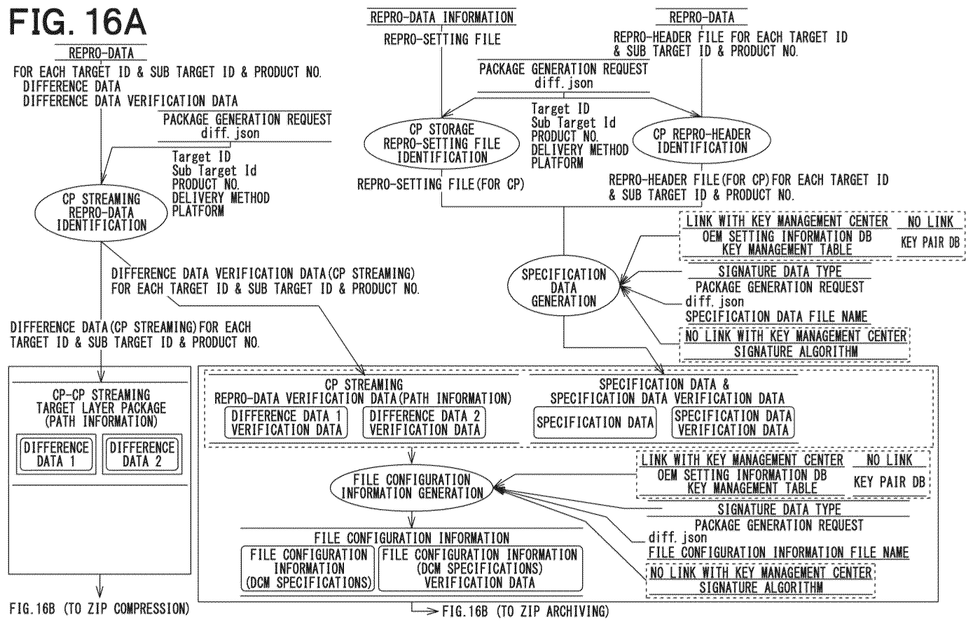

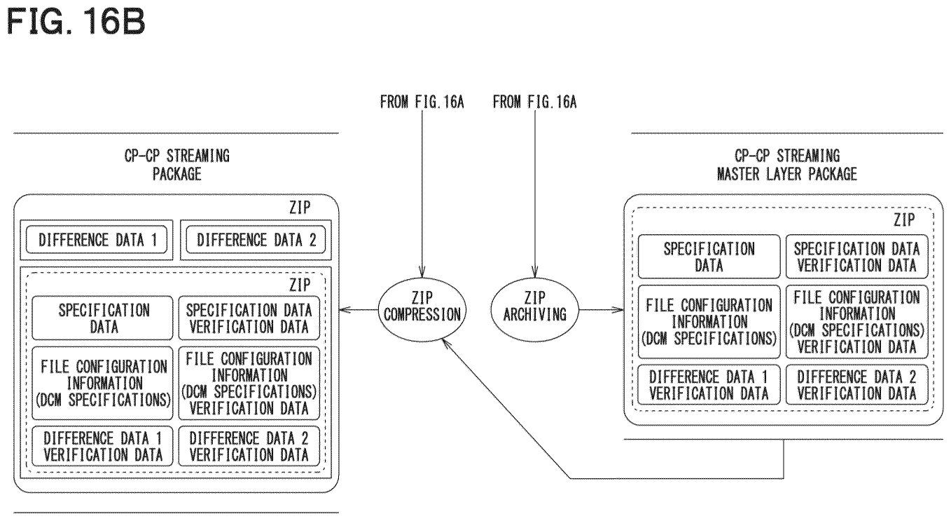

As illustrated in FIG. 16A and FIG. 16B, specification data and its verification data are generated similarly to the case of FIG. 14A and FIG. 14B. When the update data for the CP streaming is identified, a target layer package for the corresponding difference data and the verification data of the difference data are generated. These are collectively compressed into a ZIP file.

### <CP-CP Storage and CP-CP Streaming Mixed>

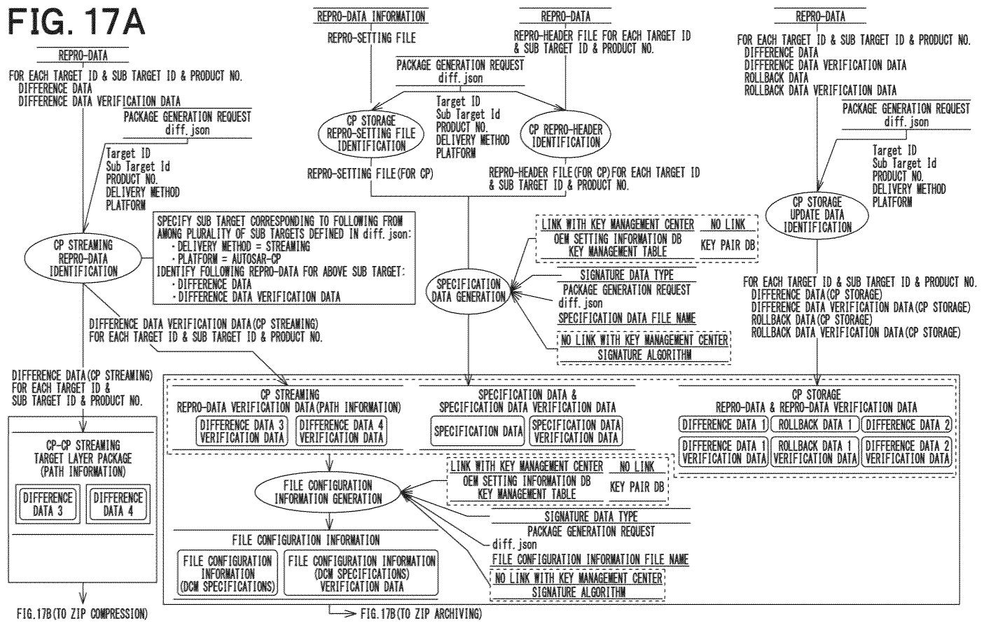

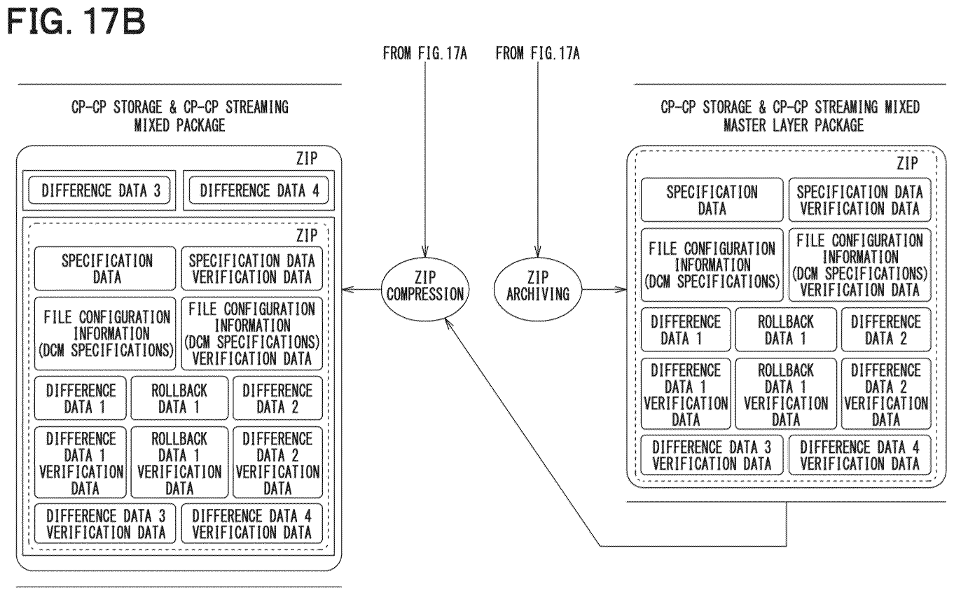

In this case, as illustrated in FIG. 17A and FIG. 17B, a pattern integrating FIGS. 14 and 16 is formed, combining the data for the CP-CP storage and the data for the CP-CP streaming into a single package.

### <AP-CP Storage>

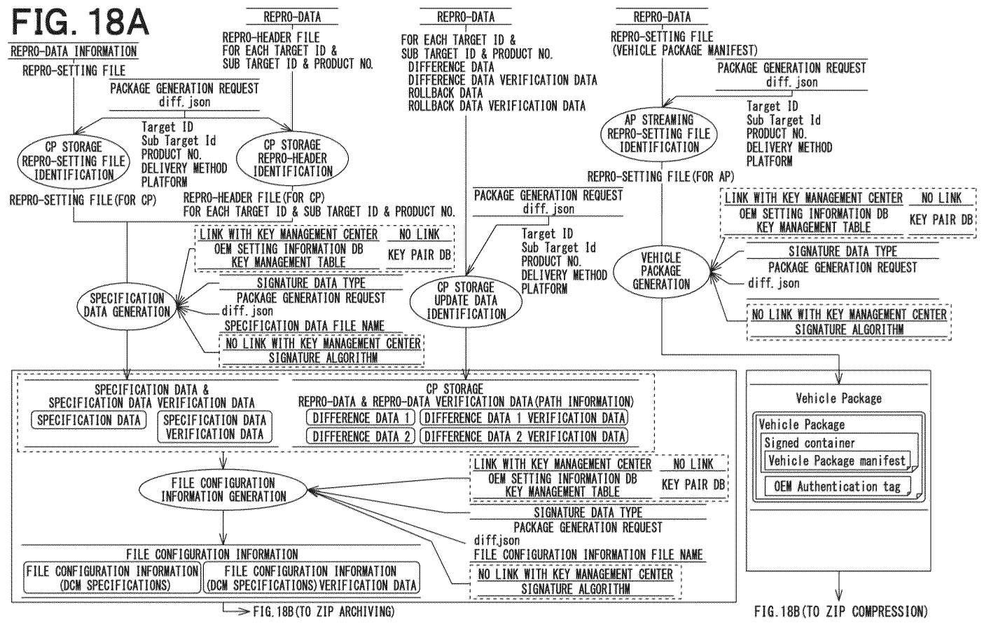

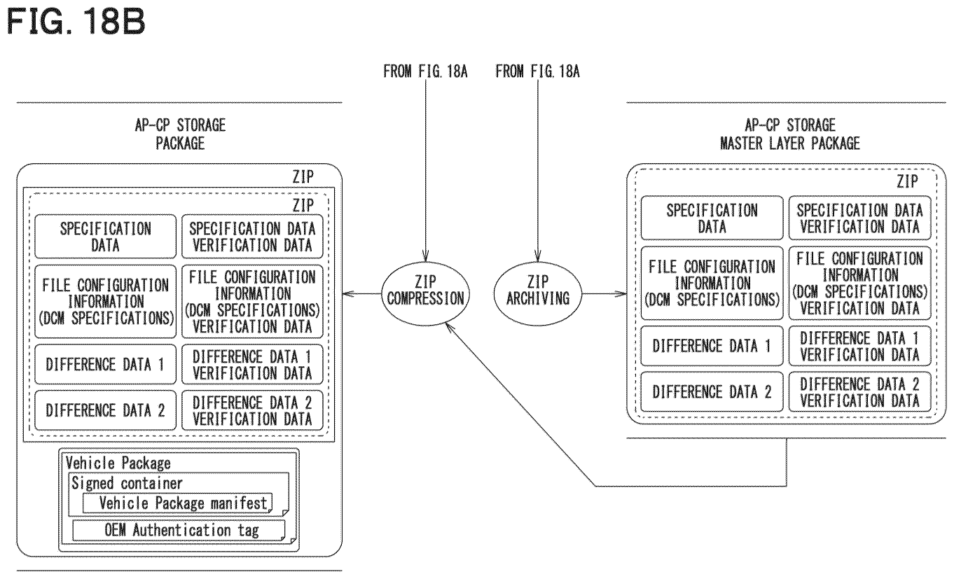

As illustrated in FIG. 18A and FIG. 18B, the process related to the CP storage portion is similar to that in FIG. 14A and FIG. 14B, but the repro-data and its verification data do not include rollback data. In the process related to the AP storage portion, only a vehicle package is generated similarly to FIG. 15A and FIG. 15B.

### <AP-CP Streaming>

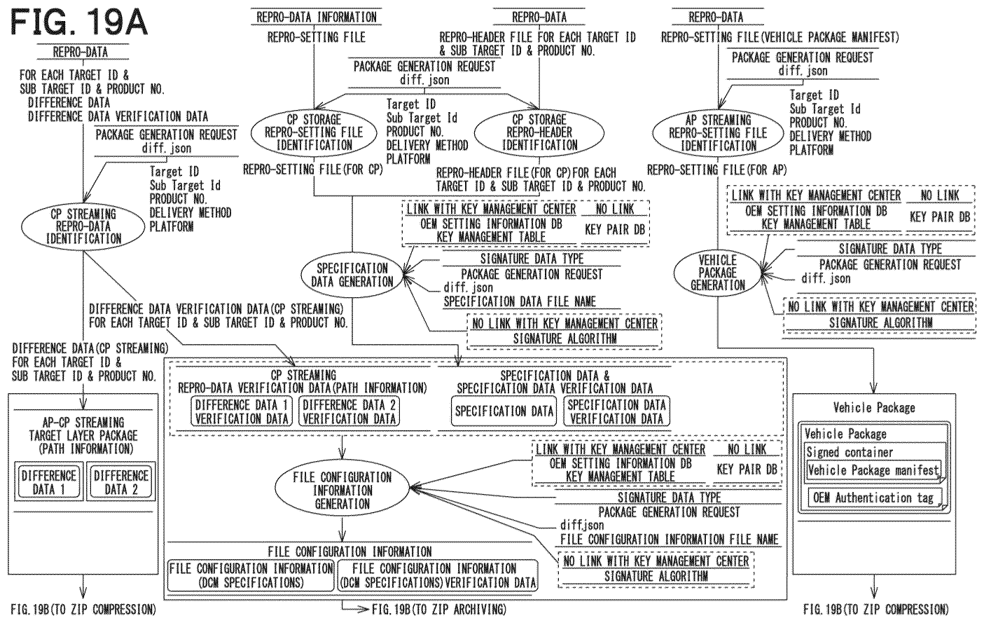

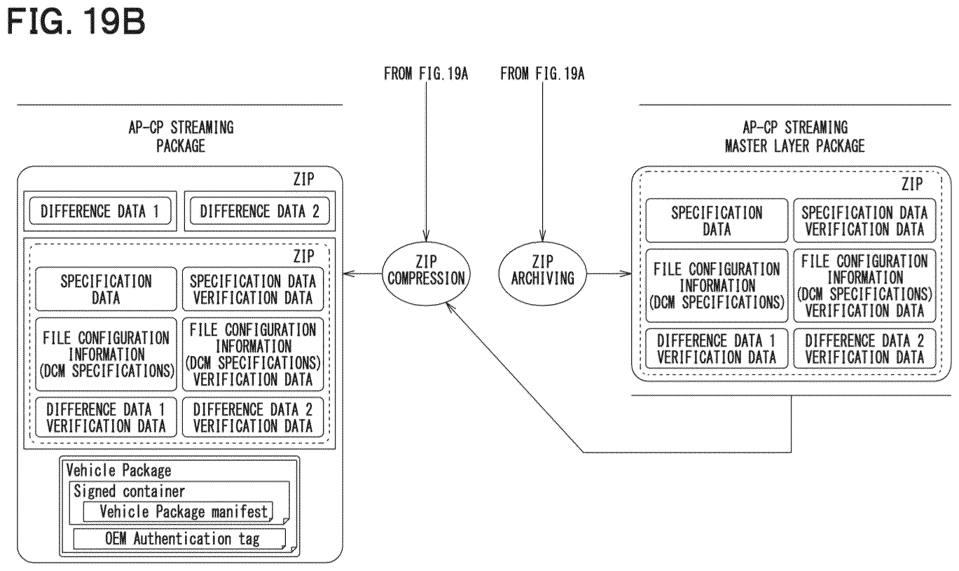

As illustrated in FIG. 19A and FIG. 19B, the generation of a vehicle package is added to the process illustrated in FIG. 16A and FIG. 16B.

### <AP-CP Storage and AP-AP Streaming Mixed>

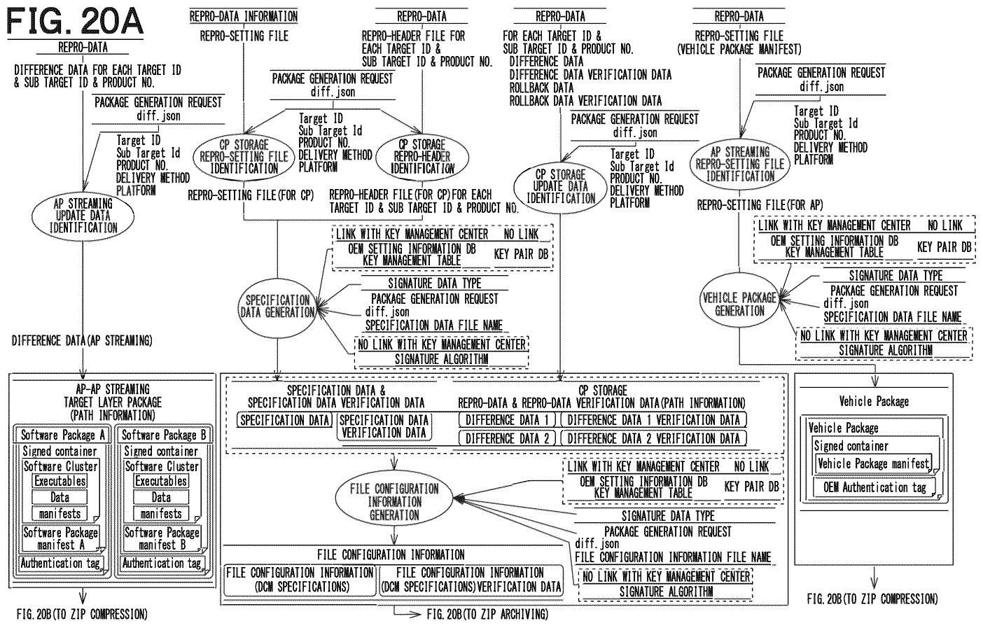

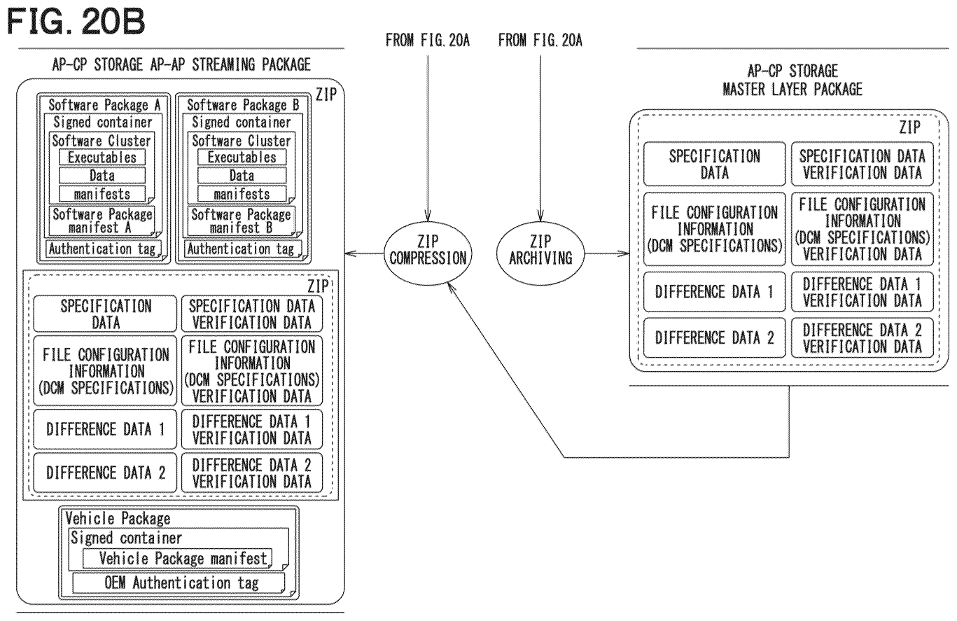

As illustrated in FIG. 20A and FIG. 20B, the process illustrated in FIG. 15A and FIG. 15B and the process illustrated in FIG. 18A and FIG. 18B are integrated.

As described above, according to the present embodiment, in the center device 1, the PKG generation server 2 acquires the ID assigned to the logic for generating the package to be distributed to the vehicle, with reference to the manifest file registered in the file registration section 6. In the logic ID management DB 4, the ID is registered according to the specifications of the OTA master 12 that receives the distributed package on the vehicle side and transfers update data to the target ECU 13. The PKG generation server 2 acquires the information on the OTA master 12 corresponding to the ID from the logic ID management DB 4. When the logic corresponding to the ID is acquired from the logic ID management DB 4, the PKG generation server 2 generates a package on the basis of the logic.

That is, by registering the manifest file in advance in the file registration section 6, the ID assigned to the logic can be acquired from the file. When the ID is acquired, the information on the OTA master 12 and the logic corresponding to the ID can be acquired, so that the PKG generation server 2 can generate a package corresponding to the specifications of the OTA master 12 on the basis of the acquired logic.

In addition, the PKG generation server 2 acquires the logic ID from the manifest file on condition that the information on the OTA master 12 could not be acquired from the back office 7. That is, when necessary information is available from the back office 7 at the time of the package generation request, the package can be generated on the basis of the information acquired from the back office 7. In a case where necessary information cannot be obtained from the back office 7, the logic ID can be acquired from the manifest file to generate a package.

Furthermore, the PKG generation server 2 associates the generated package with the information related to the OTA master 12 corresponding to the logic ID, and transmits the package to the distribution server 3. As a result, the distribution server 3 can distribute the package to the vehicle in which the OTA master 12 to be distributed is mounted.

Moreover, the distribution server 3 includes the configuration information DB 9 in which the device identification information for each of the plurality of target ECUs 13 and the vehicle-related information related to the identification of the data stored in the device are stored together with the type of vehicle, and compares the information related to the OTA master 12 with the content of the configuration information DB 9 to identify the vehicle to which the package is to be distributed. When the information related to the OTA master 12 of the vehicle requesting the distribution of the package corresponds to the vehicle to which the package is to be distributed, the package is distributed. As a result, the center device 1 can appropriately distribute the generated package to the vehicle to which the package is to be distributed.

Although the present disclosure has been described in accordance with the examples, it is understood that the disclosure is not limited to such examples or structures. The present disclosure includes various modification examples and equivalents thereof. In addition, while the various combinations and configurations, which are preferred, other combinations and configurations, including more, less or only a single element, are also within the spirit and scope of the present disclosure.

Means and/or functions provided by each device or the like may be provided by software recorded in a tangible memory device and a computer that can execute the software, software only, hardware only, or some combination of them. For example, when the control device is provided by an electronic circuit that is hardware, it can be provided by a digital circuit including a large number of logic circuits, or an analog circuit.

The control unit and the method thereof of the present disclosure may be implemented by a dedicated computer provided by configuring a processor and a memory programmed to execute one or more functions embodied by a computer program. Alternatively, the control unit and the technique according to the present disclosure may be achieved by a dedicated computer provided by constituting a processor with one or more dedicated hardware logic circuits. Alternatively, the control unit and the technique according to the present disclosure may be achieved using one or more dedicated computers constituted by a combination of the processor and the memory programmed to execute one or more functions and the processor with one or more hardware logic circuits. The computer program may also be stored on a computer-readable and non-transitory tangible storage medium as an instruction executed by a computer.

What is claimed is:

1. A center device that manages data to be written to a plurality of electronic control devices installed in a vehicle, the center device comprising:
a package generation section that is configured to generate a package including update data to be distributed to the vehicle;
a logic identification information registration section that is configured to register identification information assigned to logic for generating the package in accordance with a specification of a master device that is installed in the vehicle, receives a package distributed from a center device, and transfers update data to the electronic control device;
a logic registration section in which the logic is registered;
a file registration section in which a manifest file having a description of the identification information is registered,
wherein
the package generation section includes
an identification information acquisition section that acquires the identification information with reference to the manifest file,
a master information acquisition section that acquires information on a master device corresponding to the identification information from the logic identification information registration section, and
a logic acquisition section that acquires a logic corresponding to the identification information from the logic identification information registration section, and
the package generation section generates a package on a basis of the logic.

2. The center device according to claim 1, wherein
the identification information acquisition section acquires the identification information from the manifest file on condition that the identification information acquisition section failed to acquire information on the master device from an external server.

3. The center device according to claim 1, further comprising
a package distribution section that is configured to distribute the package to the vehicle,
wherein
the package generation section associates the generated package with information related to a master device corresponding to the identification information, and transmits the package to the package distribution section.

4. The center device according to claim 3, wherein
the package distribution section includes a vehicle information storage section in which device identification information for each of the plurality of electronic control devices and vehicle-related information related to identification of data stored in each of the devices are stored together with a type of the vehicle, and
the package distribution section compares the information related to the master device with content of the vehicle information storage section to identify a vehicle to which the package is to be distributed.

5. The center device according to claim 4, wherein
the package distribution section distributes the package when information related to a master device of a vehicle requesting distribution of the package corresponds to the vehicle to which the package is to be distributed.

6. The center device according to claim 1, wherein
the master information acquisition section acquires information on the master device as a range corresponding to a configuration of each of a plurality of master devices.

7. A data package generation method in which data to be written to a plurality of electronic control devices installed in a vehicle is managed, the data package generation method comprising, during generation of a package including update data to be distributed to the vehicle:
registering identification information assigned to logic for generating the package in accordance with a specification of a master device that is installed in the vehicle, receives a package distributed from a center device, and transfers update data to the electronic control device;
registering the logic;
registering a manifest file in which the identification information is described;
acquiring the identification information with reference to the manifest file;
acquiring information on a master device corresponding to the identification information; and
acquiring logic corresponding to the identification information and generating a package on a basis of the logic.
